(19) United States
(12) Patent Application Publication
(10) Pub. No.: US 2011/0095871 A1
(43) Pub. Date: Apr. 28, 2011

(54) Forklift radio frequency identification systems for tracking pallet stacks

(76) Inventors: Kevin J. Kail, Great Falls, VA (US); Jason Kummerl, Warren, MI (US)

(21) Appl. No.: 12/923,755

(22) Filed: Oct. 6, 2010

Related U.S. Application Data
(60) Provisional application No. 61/272,554, filed on Oct. 6, 2009.

(51) Int. Cl. H04Q 5/22

(52) U.S. Cl. 340/10.6

(57) ABSTRACT

A forklift RFID system on a forklift for a stack of pallets comprising:
a forklift comprising a body, a mast mounted to the body and a fork assembly including forks moveably mounted on the mast. A RFID antenna is secured in a fixed position on the fork assembly above the forks of the forklift and a RFID reader is positioned on the fork assembly a fixed vertical distance above the RFID antenna. A user interface assembly including a touch-panel display, with the reader being hardwired to the touch-panel display is mounted on the forklift body and including a filter which retains tag identification for specific plastic pallets which are being continuous read by the RFID reader

### RELATED APPLICATIONS

Applicant claims priority from Provisional Application Ser. No. 61/272,554 filed Oct. 6, 2009

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present invention relates to radio frequency identification (RFID) systems used with a forklift for tracking pallets stacked in columns generally ranging from 20 to 30 pallets in height and more specifically to stacked pallets ranging from 10 to 19 pallets in height.

2. Description of the Prior Art

Pallets are used worldwide to aid in the transport of products of various kinds, and are generally moved with the aid of a forklift truck or forklift. Because the pallets can be lifted, moved, and stored easily, they make the transportation of products simple and fast.

Conventional pallets are square or rectangular and include areas beneath which the forks of a forklift can enter to lift the pallet and are stored in stacks for later use. Typically pallets are constructed of wood and the individual pieces of the pallet are nailed, stapled, or otherwise fastened together. Currently, an improved plastic pallet has come on the market which is uniformly sized and provides greater resistance to the negative effects of moisture, such as mold or rotting. These pallets are provided with RFID tags in each corner, placed on or inside the pallet.

RFID tags are well-known and typically include an integrated circuit (IC) that is operatively coupled to a tag antenna. The RFID tags used in the pallets of the present invention preferably resonate in the UHF or microwave frequency band, either of which enables an RFID reader to interrogate the tags from a sufficiently long read range.

The IC associated with an RFID tag typically includes a certain amount of memory in which a tag identifier is stored and perhaps other information related to the tag. When an RFID antenna transmits energy to interrogate the RFID tag, the tag responds with information from which an RFID reader can obtain the RFID tag identifier. The data obtained by the RFID reader is then compared to entries in a database of identifiers so that individual pallets in the pallet stack are identified and recorded. In that manner, information regarding each specific pallet may be obtained, updated, and provided to a user for transportation, billing, storage or inventory.

Many companies own pallets, however, for large pallet usage third party owners of pallets lease them to other companies for their use. Following the use of a pallet in one destination, the pallets might be returned to the user entity, another entity, or to a specific location for reuse, reconditioning, repair, or disposal. For pallets with RFID tags, up-to-date information including information concerning the pallet is electronically entered in a database and the tag is associated with information about the current status and the history of the pallet. Thus, tagging the pallet can help record the location of the pallet, the condition of the pallet, the time the pallet spends at any particular pallet handler, the destination and routing schedule, and history of the pallet including pallet repairs, and other information of interest to the user or owner, or both. This and other information can be obtained quickly and easily from each pallet by simply using an RFID reader to interrogate the RFID tags associated with the pallet. This information is obtained from an RFID reader on a forklift truck, allowing the RFID tags associated with each pallet in a stack of pallets to be interrogated, and the location of a particular pallet can be tracked within a warehouse, distribution center, or other facility.

Forklifts pose a challenging environment for RFID to work effectively. The bulk of the forklift is made of metal which interferes with the RF communication and forklifts are driven a fast speeds and are constantly bumping into objects so all mounted parts, namely the antenna and reader(s) on the forklift must be secured. In addition large numbers of hoses, cables and pulleys are required to operate the forklift which need to be unobstructed for the forklift to move correctly and be accessible for maintenance. In addition most antennae cables are standard coaxial cables which have limited flexibility that will make them difficult to thread. Furthermore, the carriage and forks move and slide in multiple ways which restrict the areas for placing antennas and readers and interfere with RFID readouts.

Various patents and publications have described the use of RFID tags with pallets. For example, Netherlands Publication Document 9401836 describes a process and system for the identification of pallets, in which an RFID tag (transponder) is installed in the center of the pallet. U.S. Pat. No. 7,342,496 and U.S. Patent Publication Number 2005/0076816 discloses pallets which have RFID tags mounted thereon. Antennae elements are provided in the forks of a pallet moving apparatus, which is supposed to enable a device to obtain information from the RFID tag. U.S. Pat. Nos. 5,662,048 and 5,971,592 also relate to a pallet having a data storage device from which a data collection device can obtain information.

U.S. Pat. No. 6,669,089 is directed to a forklift with two spaced RFID antennas positioned in a column on either side of the forks of the forklift. The problem that occurs with a reader on the side of the forklift or on readers placed horizontally apart is that the multiple tag readings of stacks of pallets are lost or misidentified so that tracking and inventory have unacceptable loss percentages.

Unfortunately, the above patents do not solve the problem of accurately identifying individual pallets within stacks of pallets as the systems pick up stray RFID tags within the warehouse leading to erroneous readings. Furthermore, when pallets are read by forklifts, issues are encountered upon widening the forks of the forklift, as RF waves are absorbed by the forklift due to presence of metal with the result that the targeted pallets reading results are inconsistent.

These teachings do not aid in the resolution of a number of practical difficulties that are resolved by the present invention.

### SUMMARY OF THE INVENTION

The present invention provides a pallet tracking system for tracking stacks of pallets ranging in height from 20 to 30 pallets and more preferably, stacks of pallets ranging from 10 to 19 pallets in height. A working embodiment of the pallet tracking system comprises: a) at least one RFID reader positioned in an elevated position on a back frame of a forklift; b) at least one RFID antenna positioned above and between the forks of the forklift beneath the RFID reader; and c) a pallet including identical RFID tags in each corner to enable said RFID tags to be interrogated by an RFID reader antenna. The RFID tag readings are filtered by software which allows for separation of tag reads and the results displayed on a touch screen display mounted in the cab of the forklift.

It is an object of the invention to provide a forklift reading system which does not require precise operator alignment of the forks to obtain accurate pallet readings.

Another object of the present invention provides a specifically configured forklift having a mast and a load backrest with an RFID antenna positioned within the forks of the forklift and a RFID reader positioned above the antenna and the driver.

It is still another object of the invention to provide a forklift system which eliminates stray reading of other non stacked pallets with filtration software.

It is yet another object of the invention to provide pallets having all four corners tagged with RFID tags, each individual pallet being provided with multiple, identical RFID tags.

These and other objects, advantages, and novel features of the present invention will become apparent when considered with the teachings contained in the detailed disclosure along with the accompanying drawings.

### BRIEF DESCRIPTION OF THE DRAWINGS

The present invention will be described with reference to the appended Figures, in which:

FIG. 1 illustrates a perspective view of a forklift having the RFID reader and RFID antenna spaced vertically on the center line of the forklift;

FIG. 2 is a an enlarged view of a forklift upper RFID reader

FIG. 3 is an enlarged front view of the lower RFID antenna according to the present invention;

FIG. 4 is a rear perspective view of the forklift shown in FIG. 1; and

FIG. 5 is a perspective view of a stack of plastic pallets having imbedded RFID tags in each corner.

### DESCRIPTION OF THE INVENTION

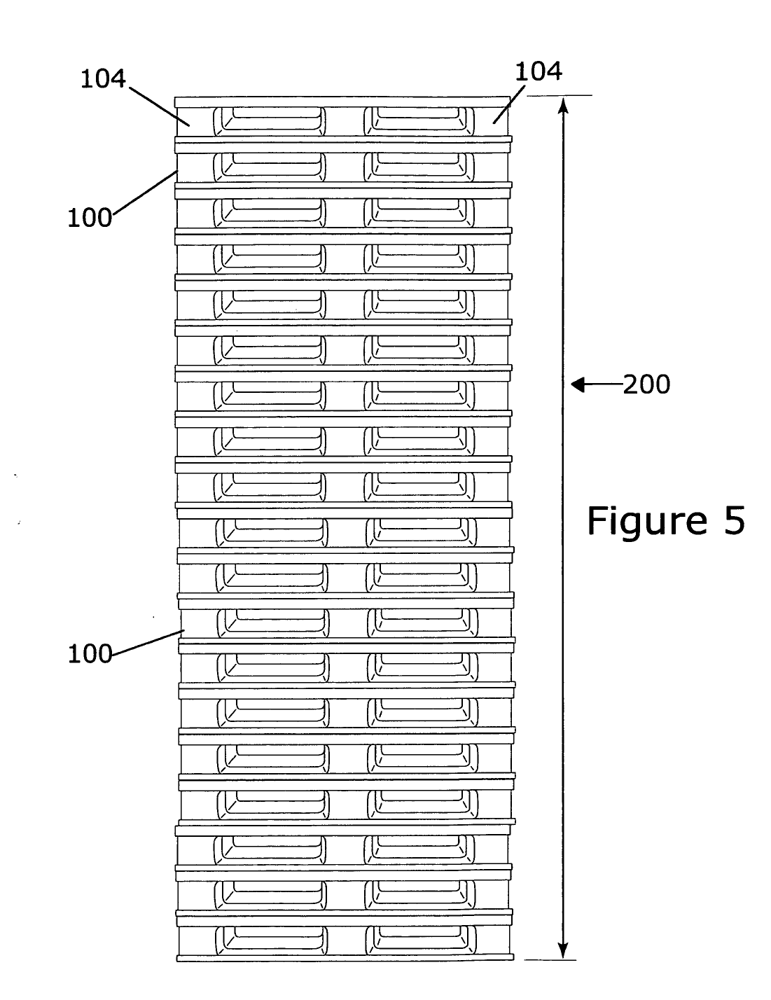

The present invention is directed toward identifying pallets, preferably plastic pallets themselves as opposed to pallets holding goods. The use of pallets is prevalent in modern day industry and large numbers of pallets are shipped and moved throughout storage facilities. The pallets come in standard sizes and define fork apertures which can receive the tines of a standard forklift. Thus, there exists a need to account for and correctly inventory the individual pallets in a stack of pallets. Accordingly, the present invention reads and identifies a stack of pallets, and each individual plastic pallet in the stack. While the pallet can be provided with one or more RFID tags, it is preferred that each plastic pallet has multiple, identical RFID tag(s) with a single RFID tag located inside each corner of the pallet or in three corners of the pallet. As a result of the placement, the information regarding the plastic pallet is more easily and reliably obtained when the RFID reader interrogates the RFID tag(s). The invention is directed toward identifying individual pallets in pallet stacks ranging from 2 to 30 pallets in height and is specifically directed toward identifying individual pallets in pallets stacks ranging from 10 to 19 pallets in height and is most preferably directed toward pallet stacks which are 19 individual pallets in height. An exemplary pallet stack of 19 individual pallets is shown in FIG. 5

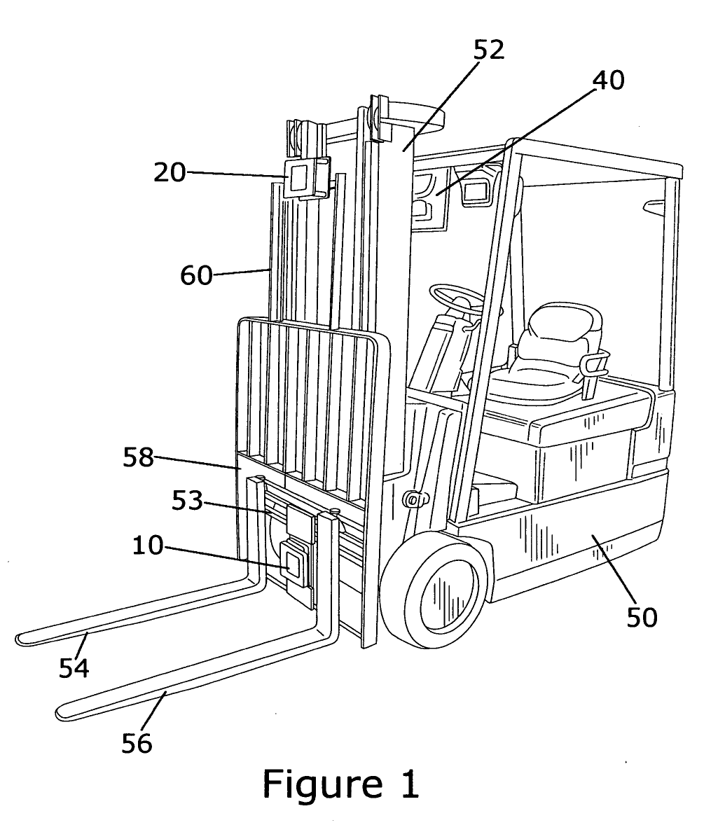

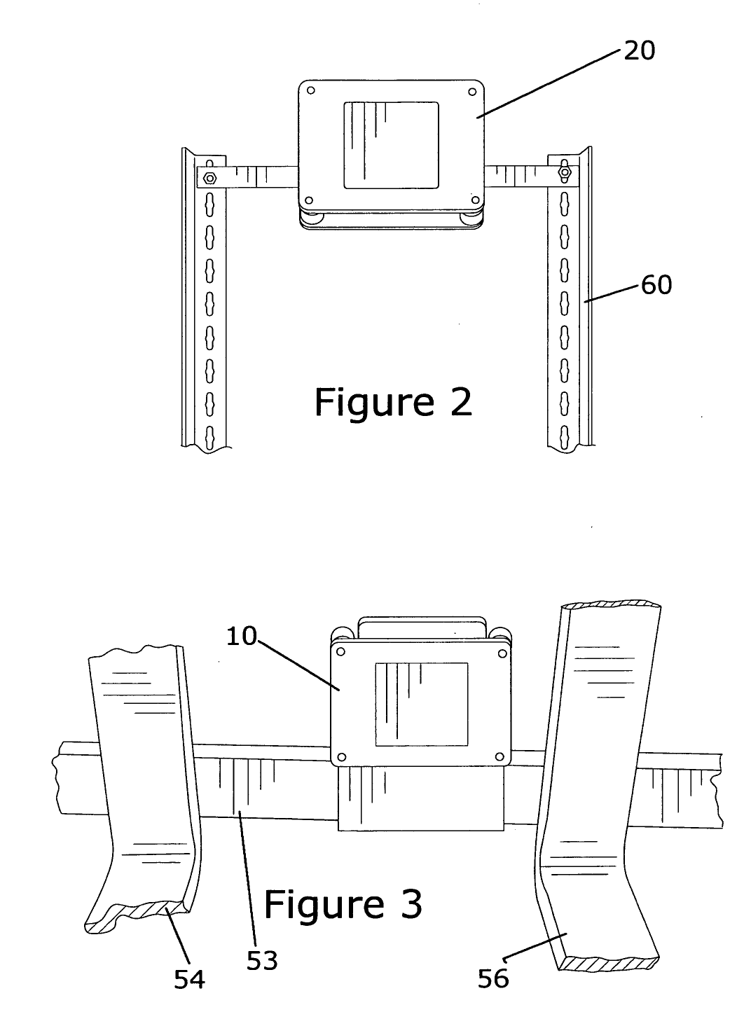

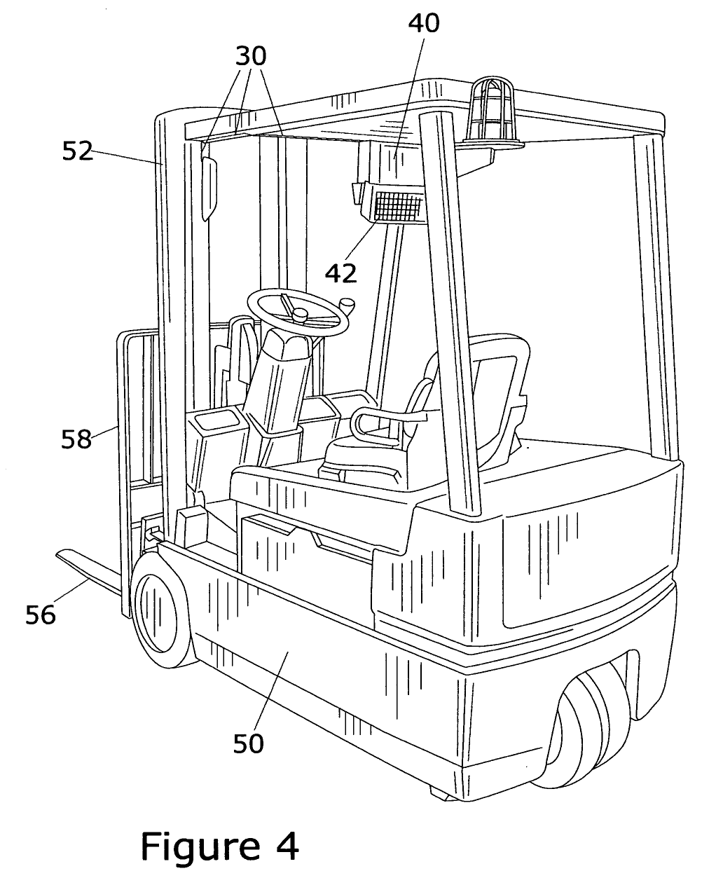

As shown in FIG. 1, an antenna 10 and reader 20 are mounted to the forklift 50 to successfully interrogate RFID tags (not shown) on plastic pallets 100 placed in a stack of pallets 200 as shown in FIG. 5.

An antenna/reader array is necessary to enable the RFID forklift system to interrogate all those pallets substantially simultaneously. Antenna such as mobile Mark Near Field, Comtelco Circular Pollarized Antenna, Comtelco Liner Polarized Antenna and Motorola RF1000 antenna have been used with the present invention. Readers such as Alien 9900, Motorola RD5000, Motorola XR450 and Things Magic Mercury4e have also been used with the invention. The preferred terminal used in the system is the LXE Touch Screen. All of the above components in the system are standard over the counter instrumentation which are readily available. It is acknowledged that other equivalent antenna, readers and screens could be used with the invention.

The preferred mounting and orientation for the antenna and reader in the RFID system is in a vertical single axis with respect to the centerline of the forklift. The antenna 10 is preferably mounted on the carriage 53 between the forks 54/56 and the reader 20 is positioned vertically above the antenna 10 on the forklift mast 52. RFID antennas can be placed in this vertical column wherever needed to obtain adequate interrogation performance. A touch panel 40 is connected to reader 20 by a cable 30 and the touch panel 40 is connected to an inboard or remote computer and data base to allow entering and retrieval of the pallet information. The touch screen allows the operator to enter the data for a stack of pallets into the database once the pallets within a stack have been identified.

The present invention provides antennas 10 and readers 20 on forklifts 50 in a specific positioned particular manner to obtain maximum individual RFID tagged pallet reading efficiency. As shown in FIG. 1, a reader antenna array 20 comprises one reader antenna positioned in a fixed position on a back frame 58 of a forklift 50 and one antenna 10 mounted on a vertically movable fork carriage 53 of the forklift 50.

In the preferred embodiment of the invention shown in FIG. 1, a forklift 50 is equipped with one RFID antenna 10 and one RFID reader 20 although additional antenna and readers could be added. The RFID reader is connected to a display screen 40 by a cable 30 or by wireless means well known in the art. The reader 20, which has a range of about 20 to about 40 feet, is mounted the back frame extension support 60 extending upward from the back frame 58 above the driver and in front of the forklift mast 52. The antenna 10 is located in a fixed position on the fork carriage 53 between the two forks 54 and 56. The back frame 58 to which the carriage 53 is mounted is connected to a hydraulic lift system associated with mast 52 that lifts the back frame 58 and the carriage and forks, to elevate the pallet load. The lift system is also able to shift the frame and forks from side-to-side, and the forks themselves are typically laterally adjustable to enable them to fit under or within pallets of different dimensions. The frame and forks are movable. The tag information read by the reader is fed to a computer which uses filter software which compares tag identification for specific pallets which are being continuously read by the reader and eliminates those tags which do not show a substantially continuous read.

The positioning of the antennae shown in FIG. 1 provides several advantages. First, antenna 10 and RFID reader 20 are positioned so as not to obscure the forward view of the forklift operator so that operating ability of the driver is not impaired.

Another advantage of an antenna arrangement of this type, where the antenna(e) that are provided on the fixed portion of the forklift are positioned above the frame and forks when the latter are in their lowered position, is that essentially all of the pallets of a stack of empty RFID-tagged pallets can be interrogated almost simultaneously by the one antenna.

Cable or cables 30 are used to connect the various components of the present invention (including the RFID reader, the RFID antennae, a power source, a touch-panel display 40 or other user interface) and should be sufficiently durable and protected to avoid damage in the conditions to which the forklift is expected to be exposed. Forklifts are notorious for inflicting and sustaining damage, and the components and connections should, to the extent possible, be covered or otherwise protected. To the extent that cables connect components on the fixed portion of the forklift to ones on the movable part, those cables can be festooned through pulleys or other suitable structures to maintain their position and appropriate tension.

The system of the present invention as previously noted preferably also includes a user interface, such as a display 40 (which may be a touch-panel display) visible to an operator of the forklift, a keyboard 42, and a removable data storage device (such as a floppy disc drive, or flash memory card). The user interface preferably is adapted to display information to the operator regarding the pallets interrogated by the RFID reader antenna, the pallets (which information may be available from the RFID tags, a database, or a combination of the two), how many RFID tags were successfully interrogated, which location tag(s) are the closest, which location tags maintain a constant sensing and other information of the type described earlier. The user interface enables the operator to input additional data (for example through the touch-panel display or keyboard), such as the condition of the pallet or its contents, the time that it was picked up or dropped off, the operator's identity, or other such information. The touch-screen display may also include a calibration system, so that no keyboard is required when a screen is repaired or replaced.

Since there are a great number of pallets 100 on the premises it is necessary to filter the information so that only the pallets in the pallet stack 200 are read. Each pallet 100 is preferably provided with four identical RFID tags inside the pallet, one in each corner of the pallet, the general location of which is shown at 104. Since the pallets are plastic, the tags 104 are buried in each corner of the pallet in an internal tube shaped support. Each pallet 100 is preferably provided with RFID tags which have identical information allowing each pallet to be read regardless of the direction or angle of the antenna exciter.

The advantages of the present invention are numerous and substantial. Among them are the ability to successfully interrogate multiple pallets, and the ability to approach and interrogate multiple pallets or multiple pallet loads from any one of four directions. Although the present invention has been described primarily with reference to pallets, persons of skill in the art will understand that these teachings can also be applied to containers, bins, racks, totes, or other storage devices.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What we claim is:

1. A forklift RFID system for identifying RFID tagged pallets in a stack of pallets comprising:
a) a forklift comprising a body, a mast mounted to said body and a fork assembly provided with a plurality of forks moveably mounted on said mast;
b) at least one RFID antenna secured in a fixed position on said fork assembly above the forks;
c) at least one RFID reader positioned on said fork assembly a fixed distance above said RFID antenna,
d) said RFID antenna and said RFID reader being vertically movable with respect to the said forklift body while maintaining a constant spacing;
e) a user interface assembly including a touch-panel display mounted to said forklift body, said RFID reader being hardwired to said touch-panel display and
d) software adapted to provide information to the touch-panel display identifying which RFID tags have been interrogated by the antenna and read by said reader, said software including filter means which retains tag identification for specific pallets which are being continuous read by said RFID reader

2. The forklift RFID system of claim 1 wherein each of said pallets is plastic and has an RFID tag located in each corner.

3. The system RFID system of claim 1 wherein said pallet stack ranges from 10 to 19 pallets in height.

4. The forklift RFID system of claim 1 wherein said pallet stack is 19 pallets in height.

5. The forklift RFID system of claim 2 wherein each individual pallet has pallet tags with i the same RFID identification.

6. The forklift RFID system of claim 1 wherein the system further comprises software adapted to provide information to a user interface identifying the pallets in a single pallet stack.

7. The forklift RFID system of claim 1 wherein the said RFID reader is a long range scanning reader with a range of about 20 to about 40 feet.

8. The forklift RFID system of claim 1 wherein said antenna interrogates said pallets substantially simultaneously.

9. The forklift RFID system of claim 1 wherein said touch-panel display has an associated keyboard.

10. The forklift RFID system of claim 1 wherein said touch-panel display has a removable data storage device.

11. A forklift RFID system for identifying RFID tagged plastic pallets in a stack of plastic pallets, comprising:
a) a forklift having a mast and a fork assembly with fork tines mounted to said mast;
b) an RFID antenna and RFID reader vertically positioned with respect to each other at a fixed distance within a column defined by said fork tines; said RFID reader being positioned above said RFID antenna at least three feet,
c) a user interface including a touch-panel display mounted to said forklift electrically connected to said RFID reader; and
d) means for filtering out RFID tags that have not been consistently interrogated and transmitting the remaining RFID tags to said touch-panel display.

12. The forklift RFID system of claim 11 wherein said pallets each have an RFID tag located in each corner.

13. The system RFID system of claim 11 wherein said pallet stack ranges from 10 to 19 pallets in height.

14. The forklift RFID system of claim 11 wherein said user interface between said tough-panel display and said RFID reader is wireless.

15. The forklift RFID system of claim 12 wherein all of said plastic pallet RFID tags in an individual plastic pallet have the same RFID identification reading.

16. The forklift RFID system of claim 11 wherein the filtering means includes software adapted to provide information to a user interface regarding a pallet.

17. A forklift RFID system for identifying RFID tagged plastic pallets in a stack of plastic pallets comprising:
a) a forklift comprising a body, a mast mounted to said body and a fork assembly moveably mounted on said mast, said fork assembly comprising a back frame mounted to said mast, a support frame mounted to said back frame and forks mounted to said back frame;
b) at least one RFID antenna secured in a fixed position on said back frame above the forks of the forklift on a vertical axis with respect to the center point of said forks;
c) at least one RFID reader positioned on said support frame at a fixed constant distance above said RFID antenna on a vertical axis with respect to the center point of said forks;
d) said RFID antenna and said RFID reader being vertically movable with respect to the said forklift body;
e) a user interface assembly including a touch-panel display, a keyboard and a removable data storage device, said reader being electrically connected to said touch-panel display and
d) means to provide information to the touch-panel display identifying which RFID tags have been interrogated by the antenna and read by said RFID reader and filter means which retains tag identification for specific plastic pallets which are being continuous read by said RFID reader.

18. The forklift RFID system as claimed in claim 17 wherein each of said pallets is plastic and has an RFID tag located in each corner.

19. The forklift RFID system of claim 17 wherein said RFID reader has a range from about 20 to about 40 feet.

20. The forklift RFID system of claim 17 wherein all of said RFID tags for an individual plastic pallet have the same RFID identification read.
